(19) United States
(12) Patent Application Publication
(10) Pub. No.: US 2014/0017400 A1
(43) Pub. Date: Jan. 16, 2014

(54) DECORATIVE GRASS HAVING A DECORATIVE PATTERN FORMED OF GLITTER AND METHODS OF PRODUCING AND USING SAME

(71) Applicant: Wanda M. Weder and William F. Straeter, not individually but solely as Trustees of the Family, Highland, IL (US)

(72) Inventor: Donald E. Weder, Highland, IL (US)

(73) Assignee: Wanda M. Weder and William F. Straeter, not individually but solely as Trustees of the Family, Highland, IL (US)

(21) Appl. No.: 14/030,681

(22) Filed: Sep. 18, 2013

Related U.S. Application Data
(63) Continuation of application No. 12/985,759, filed on Jan. 6, 2011, now abandoned.
Application No. 12/985,759 is a continuation of application No. 11/810,625, filed on Jun. 6, 2007, now abandoned.
Application No. 11/810,625 is a continuation of application No. 11/521,097, filed on Sep. 14, 2006, now abandoned.
Application No. 11/521,097 is a continuation of application No. 10/726,085, filed on Dec. 2, 2003, now abandoned.
Application No. 11/810,625 is a continuation-in-part of application No. 11/129,871, filed on May 16, 2005, now abandoned.
Application No. 11/129,871 is a continuation of application No. 10/316,818, filed on Dec. 10, 2002, now abandoned.
Application No. 10/316,818 is a continuation of application No. 09/637,828, filed on Aug. 11, 2000, now abandoned.
Application No. 09/637,828 is a continuation of application No. 09/040,940, filed on Mar. 18, 1998, now Pat. No. 6,258,447.

(51) Int. Cl. B05D 3/00; B26D 3/00

(52) U.S. Cl. CPC B05D 3/007; B26D 3/00
USPC 427/202; 83/13

(57) ABSTRACT

Materials that have a decorative pattern formed of glitter are disclosed, along with methods of producing and using these materials.

### CROSS REFERENCE TO RELATED APPLICATIONS/INCORPORATION BY REFERENCE STATEMENT

This application is a continuation of U.S. Ser. No. 12/985,759, filed Jan. 6, 2011, now abandoned; which is a continuation of U.S. Ser. No. 11/810,625, filed Jun. 6, 2007, now abandoned; which is a continuation of U.S. Ser. No. 11/521,097, filed Sep. 14, 2006, now abandoned; which is a continuation of U.S. Ser. No. 10/726,085, filed on Dec. 2, 2003, now abandoned. U.S. Ser. No. 11/810,625 is also a continuation-in-part of U.S. Ser. No. 11/129,871, filed May 16, 2005, now abandoned; which is a continuation of U.S. Ser. No. 10/316,818, filed Dec. 10, 2002, now abandoned; which is a continuation of U.S. Ser. No. 09/637,828, filed Aug. 11, 2000, now abandoned; which is a continuation of U.S. Ser. No. 09/040,940, filed Mar. 18, 1998, now U.S. Pat. No. 6,258,447, issued Jul. 10, 2001. The entire contents of each of the above-referenced patents and patent applications are hereby expressly incorporated herein by reference.

### STATEMENT REGARDING FEDERALLY SPONSORED RESEARCH OR DEVELOPMENT

Not applicable.

### BRIEF DESCRIPTION OF THE DRAWINGS

FIG. 1 is a perspective view of a sheet of material having a decorative pattern formed of glitter on a surface thereof constructed in accordance with the presently disclosed and claimed inventive concept(s).

FIG. 2 is a perspective view of a sheet of material having a decorative pattern formed of glitter on a surface thereof similar to the sheet of material of FIG. 1 wherein a bonding material is disposed along one edge thereof.

FIG. 3 is a perspective view of a sheet of material having a decorative pattern formed of glitter on a surface thereof of FIG. 2 having a floral grouping disposed thereon.

FIG. 4 is a perspective view of the floral grouping of FIG. 3 being wrapped with the sheet of material having a decorative pattern formed of glitter on a surface thereof of FIG. 2 by one method of wrapping.

FIG. 5 is a perspective view of a decorative cover for the floral grouping formed from the sheet of material of FIG. 2 wherein the decorative cover formed from the sheet of material has a conical configuration.

FIG. 6 is a perspective view of a decorative cover formed from the sheet of material of FIG. 2 wherein a floral grouping is wrapped with the sheet of material by a second method of wrapping so that the decorative cover has a substantially cylindrical configuration.

FIG. 7 is a perspective view of a decorative cover positioned about a flower pot wherein the decorative cover is formed from the sheet of material having a decorative pattern formed of glitter on a surface thereof of FIG. 1.

FIG. 8 is a cross-sectional view of a flower pot cover former and band applicator apparatus having the sheet of material having a decorative pattern formed of glitter on a surface thereof of FIG. 1 disposed above an opening of the flower pot cover former and band applicator and having a flower pot disposed above the sheet of material.

FIG. 9 is a perspective view of a sheet of flexible laminated material having a decorative pattern formed of glitter visible on a surface thereof.

FIG. 10 is a perspective view of a preformed pot cover formed from the sheet of flexible laminated material of FIG. 9.

FIG. 11 is a perspective view of the preformed pot cover of FIG. 10 having a flower pot disposed therein.

FIG. 12 is a diagrammatic, cross-sectional view of a male and female mold having the sheet of flexible laminated material of FIG. 9 disposed therebetween for forming the preformed pot cover of FIG. 10.

FIG. 13 is a perspective view of a floral sleeve having a decorative pattern formed of glitter visible on a surface thereof.

FIG. 14 is a perspective view of the floral sleeve of FIG. 13 disposed about a floral grouping.

FIG. 15 is a perspective view of a floral sleeve having a cinching member wherein the floral sleeve has a decorative pattern formed of glitter visible on a surface thereof.

FIG. 16 is a perspective view of the floral sleeve of FIG. 15 disposed about a floral grouping.

FIG. 17 is a side view of a sleeve having a detachable portion wherein the sleeve has a decorative pattern formed of glitter visible on a surface thereof.

FIG. 18 is a perspective view of the sleeve of FIG. 17 having a flower pot disposed therein.

FIG. 19 is a perspective view of a flower pot disposed in the sleeve of FIG. 17 wherein an upper portion of the sleeve has been removed to provide a decorative cover having a skirt.

FIG. 20A is a perspective view of a ribbon material having a decorative pattern formed of glitter disposed on a surface thereof.

FIG. 20B is a perspective view of a ribbon material formed of a laminated material and having a decorative pattern formed of glitter visible on a surface thereof.

FIG. 21 is a schematic representation of a system for making decorative grass having a decorative pattern formed of glitter in accordance with the presently disclosed and claimed inventive concept(s).

FIG. 22A is a perspective view of a segment of decorative grass having a decorative pattern formed of glitter.

FIG. 22B is a perspective view of a segment of decorative grass having a decorative pattern formed of glitter produced from a laminated material.

### DETAILED DESCRIPTION

Before explaining at least one embodiment of the presently disclosed and claimed inventive concept(s) in detail, it is to be understood that the presently disclosed and claimed inventive concept(s) is not limited in its application to the details of construction and the arrangement of the components or steps or methodologies set forth in the following description or illustrated in the drawings. The presently disclosed and claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which this presently disclosed and claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed and claimed herein can be made and executed without undue experimentation in light of the present disclosure. While the articles and methods of the presently disclosed and claimed inventive concept(s) have been described in terms of preferred embodiments, it will be apparent to those of skill in the art that variations may be applied to the articles and/or methods and in the steps or in the sequence of steps of the method described herein without departing from the concept, spirit and scope of the presently disclosed and claimed inventive concept(s). All such similar substitutes and modifications apparent to those skilled in the art are deemed to be within the spirit, scope and concept of the presently disclosed and claimed inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more”, “at least one”, and “one or more than one”. The use of the term “or” in the claims is used to mean “and/or” unless explicitly indicated to refer to alternatives only or the alternatives are mutually exclusive, although the disclosure supports a definition that refers to only alternatives and “and/or”. Throughout this application, the term “about” is used to indicate that a value includes the inherent variation of error for the device, the method being employed to determine the value, or the variation that exists among the study subjects. For example but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The use of ordinal number terminology (i.e., “first”, “second”, “third”, “fourth”, etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

Turning now to the presently disclosed and claimed inventive concept(s), materials having a decorative pattern formed of glitter, as well as objects formed therefrom, such as but not limited to, flower pot covers, floral wrappings, ribbon materials, and decorative grasses made from such materials, are contemplated herein. In addition, methods of producing and using the materials and/or objects are also contemplated within the scope of the presently disclosed and claimed inventive concept(s). In one aspect, the presently disclosed and claimed inventive concept(s) relates to methods for producing flower pot covers and methods of wrapping floral groupings and flower pots with a sheet of material having a decorative pattern formed of glitter to provide a decorative cover for such floral groupings and flower pots. In yet another aspect, the presently disclosed and claimed inventive concept(s) relates to methods of producing decorative grasses having a decorative pattern formed of glitter.

Particular embodiments of the presently disclosed and claimed inventive concept(s) will now be discussed in detail with reference to the Figures. However, it is to be understood that the Figures and the descriptions thereof are provided for the purpose of description, and the presently disclosed and claimed inventive concept(s) is not limited to such exemplary information contained therein. The inventive concept(s) is capable of other embodiments or of being practiced or carried out in various ways.

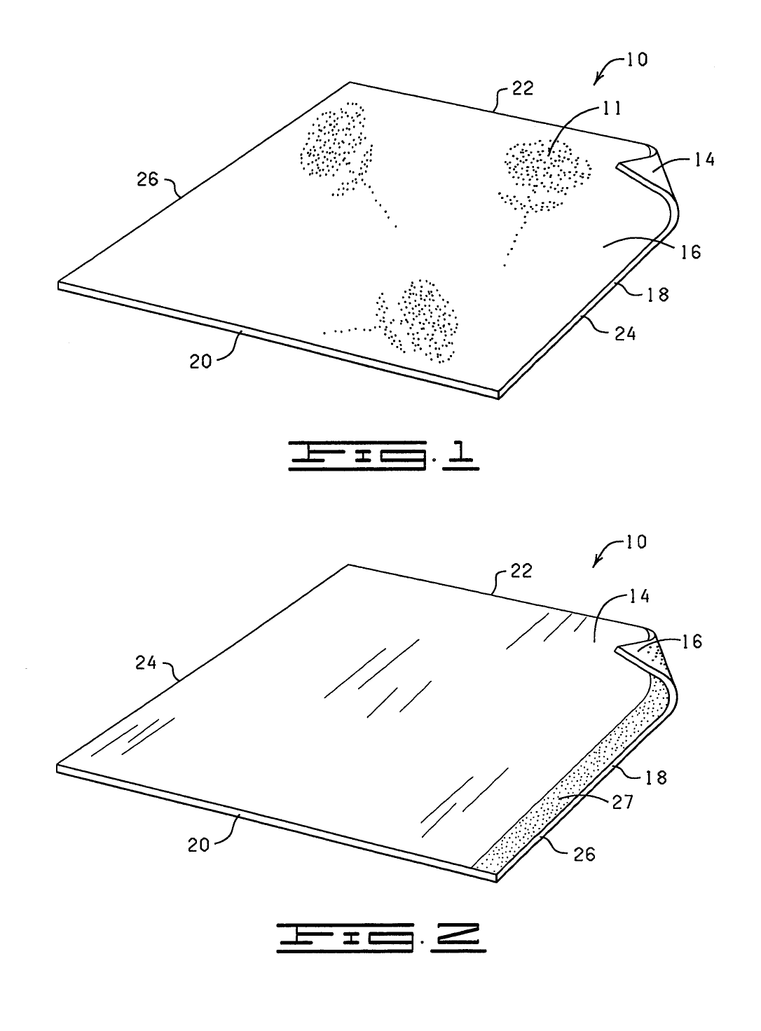

### Description of FIGS. 1-8

Referring now to FIGS. 1 and 2, designated generally by the reference numeral 10 is a sheet or web of material having a decorative pattern 11 formed of glitter (hereinafter referred to as the sheet of material 10 or the sheet of material 10 having glitter disposed thereon). That is, at least one surface of the sheet of material 10 has been modified to provide a decorative pattern 11 formed of glitter.

The term “sheet of material” as used herein will be understood to include any material or any substrate to which a decorative pattern 11 formed of glitter can be applied. For example, the material may be selected from the group consisting of polymeric film, paper, metallized film, foil, cloth (woven or nonwoven or natural or synthetic, such as, but not limited to, spun-bonded material), burlap, a sheet of material having a texture or appearance simulating the texture or appearance of paper, a sheet of material having a texture or appearance or simulating the texture or appearance of cloth, or any combination or lamination thereof.

The terms “polymer film”, “polymeric film” and “polymeric material” when used herein refer to a synthetic polymer such as a polypropylene or a polyethylene, a naturally occurring polymer such as cellophane, an extruded polymeric material having an expanded core such as extruded polypropylene having an expanded core and combinations thereof. The extruded polymeric material having an expanded core may also be referred to herein as an expanded core polymeric material.

“Extruded polymeric material having an expanded core” or “expanded core polymeric film” as used herein means any extrudable polymeric material or polymeric film in which the core is expanded during extrusion, such as by incorporation of a blowing agent in the polymeric resin which is being extruded.

The sheet of material 10 may also be constructed, in whole or in part, from a cling material. “Cling material” when used herein means any material which is capable of connecting to the sheet of material and/or itself upon contacting engagement during the wrapping process and is wrappable about an item whereby portions of the cling material contactingly engage and connect to other portions of another material, or, alternatively, itself, for generally securing the material wrapped about at least a portion of a flower pot. This connecting engagement is preferably temporary in that the material may be easily removed, i.e., the cling material “clings” to the flower pot.

The cling material is constructed, and treated if necessary, from polyethylene such as Cling Wrap made by Glad®, First Brands Corporation, Danbury, Conn. The thickness of the cling material will, in part, depend upon the size of sleeve and the size of the flower pot in the sleeve, i.e., generally, a larger flower pot may require a thicker and therefore stronger cling material. The cling material will range in thickness from about 0.1 mil to about 10 mil, and more desirably from about 0.5 mil to about 2.5 mil. However, any thickness of cling material may be utilized as long as the material functions in accordance with the presently disclosed and claimed inventive concept(s).

The sheet of material 10 has an upper surface 14, a lower surface 16, and an outer peripheral edge 18. At least a portion of one surface of the sheet of material 10, such as the lower surface 16, is provided with the decorative pattern 11 formed of glitter applied thereto. The outer peripheral edge 18 of the sheet of material 10 comprises a first side 20, a second side 22, a third side 24, and a fourth side 26. A bonding material 27 (FIG. 2) may be disposed on at least a portion of one or both surfaces of the sheet of material 10, such as the upper surface 14 thereof as shown and as further illustrated in U.S. Pat. No. 5,181,364, entitled “WRAPPING A FLORAL GROUPING WITH SHEETS HAVING ADHESIVE OR COHESIVE MATERIAL APPLIED THERETO”, issued to Weder on Jan. 26, 1993, the specification of which is hereby expressly incorporated herein by reference.

The term “glitter” as used herein will be understood to include a collection of pieces of material that, when applied to a surface of a material, provides the material with textures and/or appearances and/or surface modifications such that the material is provided with a sparkling, brilliant ornamental finish. Glitter typically comprises pieces of metallic, iridescent or holographic material or combinations thereof. However, it will be understood that the glitter utilized in the presently disclosed and claimed inventive concept(s) may be constructed of any material that provides a desired effect. Further, the size, shape, color, and substance of the particles of glitter will not be limited to that described herein, and may include unlimited ranges which fall within the scope of the presently disclosed and claimed inventive concept(s).

The decorative pattern 11 formed of glitter may be applied to the sheet of material 10 by disposing the glitter into a coating and applying the coating containing glitter to the sheet of material 10. The coating may be any type of substrate that is capable of containing the glitter and binding the glitter to the sheet of material 10. For example but not by way of limitation, the coating may be selected from the group consisting of lacquer, wax, glue, ink, bonding materials (as defined in detail hereafter) and any combination thereof or any other coating capable of functioning in accordance with the presently disclosed and claimed inventive concept(s). However, the sheet of material 10 is not limited to having the decorative pattern 11 formed of glitter applied as described herein, but may be applied by any method known by a person having ordinary skill in the art.

While it has been described herein before that the glitter is first disposed in the coating and then the coating containing the glitter is disposed on the sheet of material 10, it will be understood that the decorative pattern 11 formed of glitter may also be created by first disposing the coating alone on the sheet of material 10 and then applying glitter to the coating, such as by applying glue or other bonding material to the sheet of material 10 and then sprinkling glitter on the glue-coated surface so that the glitter adheres to the exposed glue on the surface of the sheet of material 10, thereby providing the decorative pattern 11 formed of glitter. Thus the term “applying a coating containing glitter” will be understood to encompass not only disposing the glitter in the coating prior to application to the sheet of material 10 but also encompass applying the coating to the sheet of material 10 first and then disposing the glitter on the coated surface of the sheet of material 10.

It will also be understood that a surface coating may be applied on top of the glitter and coating to prevent the decorative pattern 11 formed of glitter from being disrupted, distorted or destroyed. Any surface coating known in the art may be utilized as long as the sheet of material 10 having the surface coating thereon functions in accordance with the presently disclosed and claimed inventive concept(s) and the surface coating is substantially transparent or translucent to allow the decorative pattern 11 formed of glitter to be visible therethrough. Examples of such surface coatings include, but not by way of limitation, lacquers, extrusion coatings, films and the like.

The sheet of material 10 having the decorative pattern 11 formed of glitter may vary in color. Further, the sheet of material 10 may comprise other decorative patterns or designs in addition to the decorative pattern 11 formed of glitter, such as, but not limited to, embossing, printing, texturing, flocking, matting, application of a foamable lacquer or foamable ink, application of a matting lacquer or matting ink, and the like.

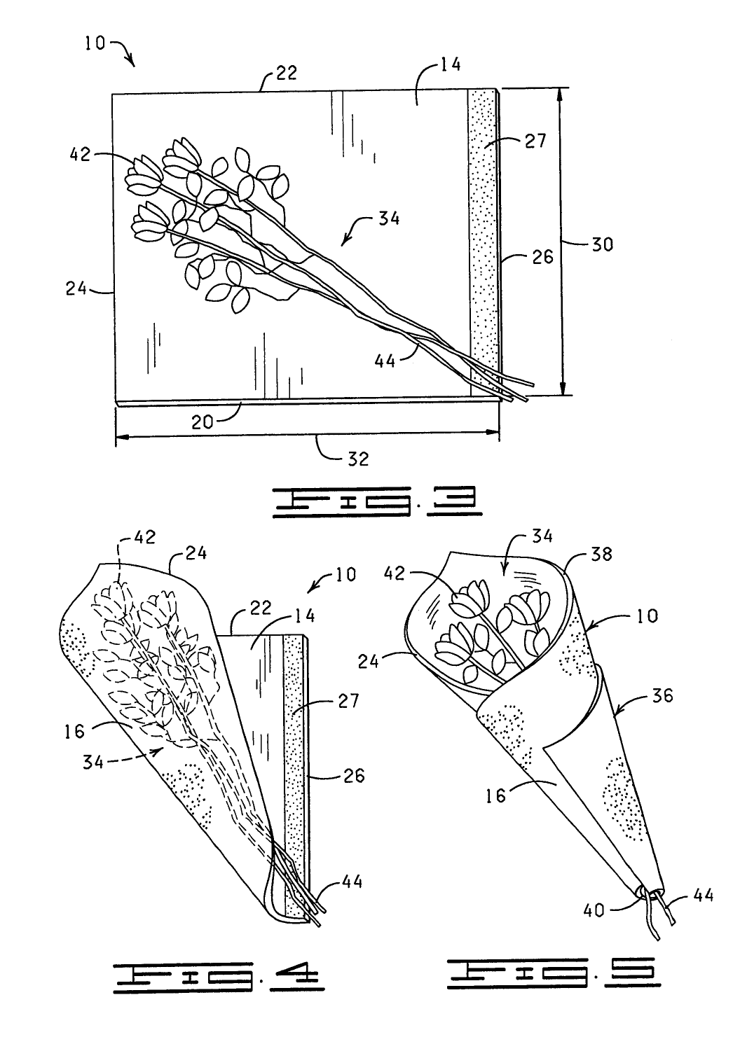

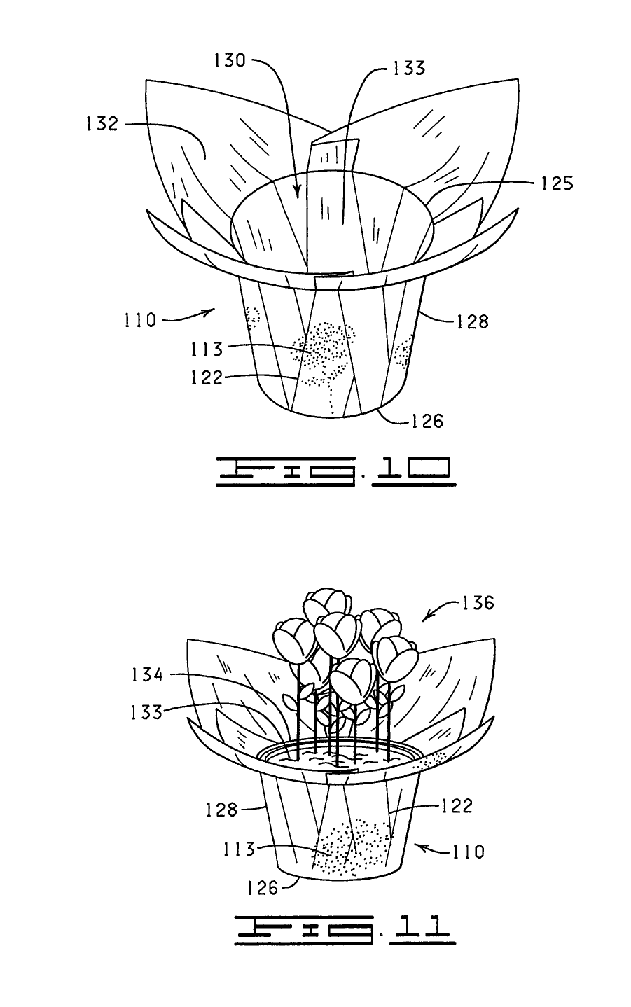

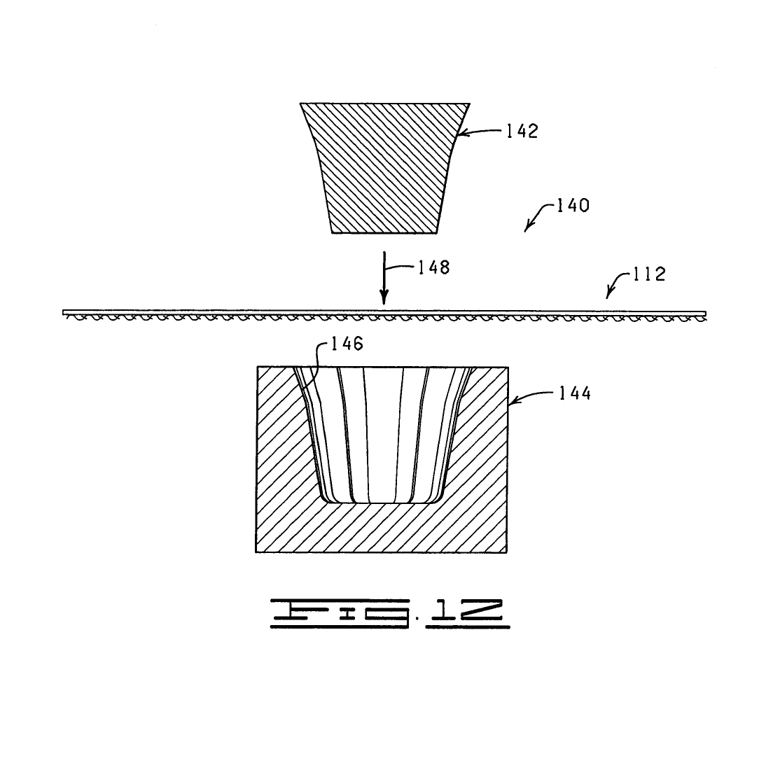

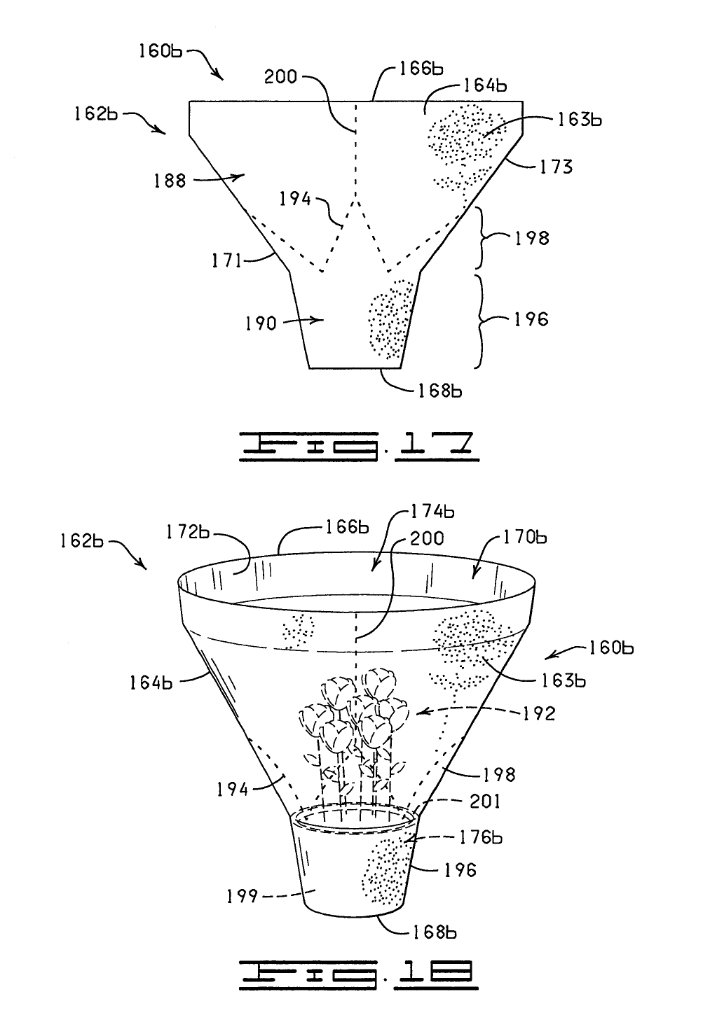

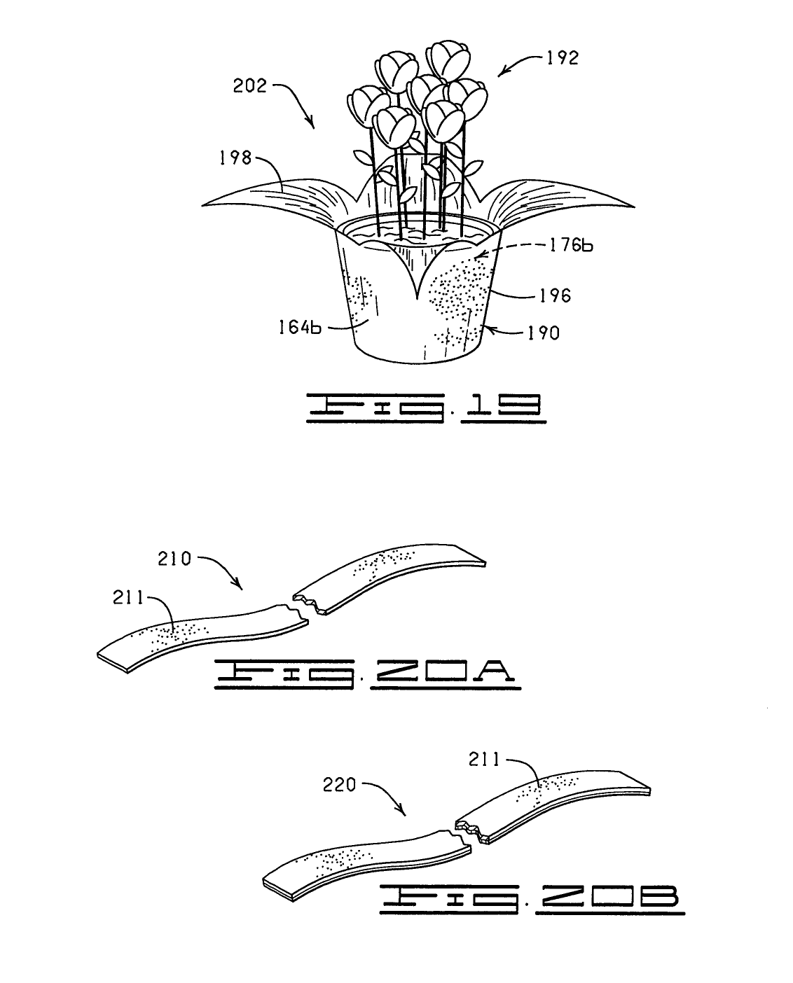

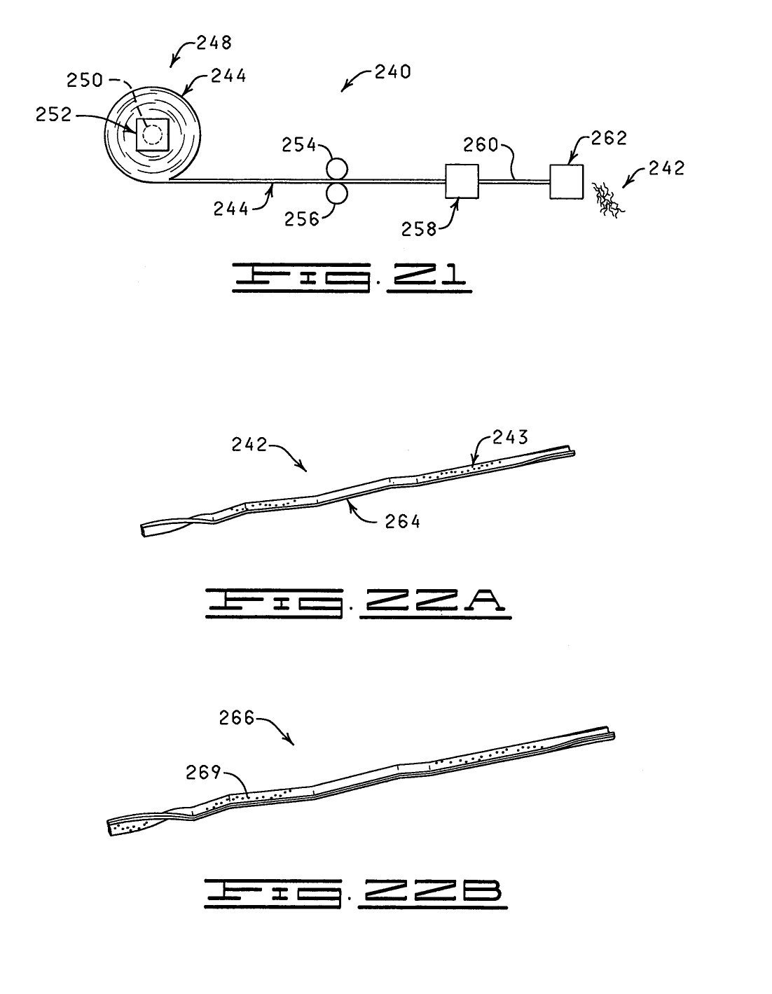

The sheet of material 10 having the decorative pattern 11 formed of glitter disposed on at least a portion of one surface thereof may be employed to provide a decorative cover for a floral grouping (FIGS. 3 through 6); or to form a decorative cover for a flower pot (FIG. 7); or to form a preformed flower pot cover for covering a flower pot (FIGS. 10 and 11); or to provide a sleeve for wrapping or covering a floral grouping (FIGS. 13 through 16) or a flower pot (FIGS. 17 through 19); or to provide a ribbon material (FIGS. 20A through 20B); or to produce decorative grass (FIGS. 21 through 22B). The use of the sheet of material 10 having the decorative pattern 11 formed of glitter to form a decorative cover for a floral grouping or a flower pot, or to form a sleeve for a floral grouping or a flower pot, or to form a preformed flower pot cover, or as a ribbon material or to produce decorative grasses will be described in more complete detail herein.

As noted above, the sheet of material 10 having the decorative pattern 11 formed of glitter can be utilized to form a decorative cover for a floral grouping or a flower pot. The term “flower pot” as used herein refers to any type of container for holding a floral grouping, or a plant, or even another pot-type container. Examples of flower pots and/or pot-type containers include, but are not limited to, clay pots, wooden pots, plastic pots, pots made from natural and/or synthetic fibers, or any combination thereof. Such flower pots and/or pot-type containers are provided with a retaining space for receiving a floral grouping. The floral grouping may be disposed within the retaining space of the flower pot with a suitable growing medium described in further detail below, or other retaining or floral holding medium, such as floral foam. It will also be understood that in some cases the floral grouping, and any appropriate growing medium or other retaining or floral holding medium, may be disposed in a sleeve formed from the sheet of polymeric material 10 if the sleeve is adapted to contain a medium.

“Floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. Further, the floral grouping may comprise a growing potted plant having a root portion as well. However, it will be appreciated that the floral grouping may consist of only a single bloom or only foliage, or a botanical item (not shown), or a propagule. The term “floral grouping” may be used interchangeably herein with the term “floral arrangement”. The term “floral grouping” may also be used interchangeably herein with the terms “botanical item” and/or “propagule”.

The term “growing medium” when used herein refers to any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item” when used herein refers to a natural or artificial herbaceous or woody plant, taken singularly or in combination. The term “botanical item” also means any portion or portions of natural or artificial herbaceous or woody plants including stems, leaves, flowers, blossoms, buds, blooms, cones, or roots, taken singularly or in combination, or in groupings of such portions such as bouquets or floral groupings.

The term “propagule” when used herein refers to any structure capable of being propagated or acting as an agent of reproduction including seeds, shoots, stems, runners, tubers, plants, leaves, roots, or spores.

In the embodiments shown in the drawings, the sheet of material 10 having the decorative pattern 11 formed of glitter is square. It will be appreciated, however, that the sheet of material 10 can be of any shape, configuration or size as long as the sheet of material 10 is sufficiently sized and shaped to wrap and encompass a floral grouping or a flower pot. For example, the sheet of material 10 may have a rectangular, round, oval, octagonal or asymmetrical shape. In addition, the sheet of material 10 may be provided with a decorative edge design on one or more sides, such as but not limited to, a scalloped edge design on one or more sides.

Further, multiple sheets of the material 10 may be used in a single circumstance to provide a decorative cover or sleeve for a floral grouping or a flower pot. Moreover, when multiple sheets of the material 10 are used in combination, the sheets of material 10 need not be uniform in size or shape. Finally, it will be appreciated that the sheet of material 10 shown herein is a substantially flat sheet except for the coating employed to provide the sheet of material 10 with the desired decorative pattern 11.

Any thickness or stiffness of the sheet of material 10 may be utilized in accordance with the presently disclosed and claimed inventive concept(s) as long as at least one surface of the sheet of material 10 can be modified to provide the sheet of material with the decorative pattern 11 formed of glitter and the sheet of material 10 having the decorative pattern 11 formed of glitter can be wrapped about at least a portion of a floral grouping or a flower pot, as described herein. Generally, the sheet of material 10 will have a thickness in a range of from about 0.1 mil to about 30 mil, and more desirably a thickness in a range of from about 0.5 mil to about 10 mil.

As illustrated in FIG. 3, the sheet of material 10 has a width 30 extending generally between the first side 20 and the second side 22, respectively, and a length 32 extending generally between the third side 24 and the fourth side 26, respectively, wherein the width 30 and the length 32 are sufficiently sized whereby the sheet of material 10 extends over a substantial portion of the floral grouping when the sheet of material 10 has been wrapped about the floral grouping in accordance with the presently disclosed and claimed inventive concept(s), as described in detail herein. The sheet of material 10 may also be wrapped about a flower pot to substantially wrap and cover the flower pot in accordance with the presently disclosed and claimed inventive concept(s).

A plurality of sheets of material 10 having the decorative pattern 11 formed of glitter may be connected together to form a roll as is shown in U.S. Pat. No. 5,459,976, issued to Weder et al. on Oct. 24, 1995, entitled “MATERIAL AND ADHESIVE STRIP DISPENSER”, the specification of which is hereby expressly incorporated in its entirety herein by reference.

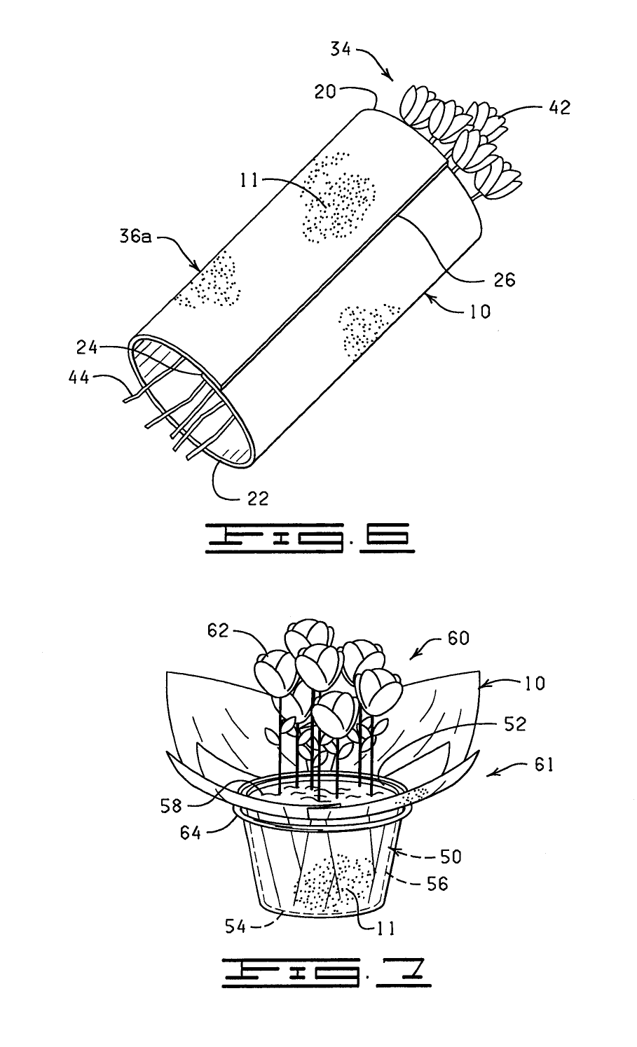

FIGS. 3-5 illustrate the use of the sheet of material 10 having the decorative pattern 11 formed of glitter disposed thereon in wrapping a floral grouping 34 to provide a decorative cover 36 (FIG. 5) for the floral grouping 34, wherein the decorative cover 36 has an open upper end 38 and a lower end 40. The sheet of material 10 may optionally have a bonding material 27 disposed upon the upper surface 14 thereof, the lower surface 16 thereof or both, such as the strip of bonding material 27 disposed along at least a portion of the upper surface 14 of the sheet of material 10 so as to be disposed substantially adjacent the fourth side 26 thereof, substantially as shown in FIGS. 3 and 4. Further, the sheet of material 10 can be provided either as an individual sheet or from a pad or roll of material.

The bonding material 27, if present, may have a backing or release strip (not shown). The backing or release strip may be left applied for a period of time to the bonding material 27 after it is disposed on a surface of the sheet of material 10 prior to its use as a wrapping material to protect the bonding qualities of the bonding strip.

In operation, an operator may dispose the sheet of material 10 having the decorative pattern 11 formed of glitter disposed thereon on a support surface such that the lower surface 16 of the sheet of material 10 (which has been modified to provide the sheet of material 10 with the decorative pattern 11 formed of glitter) is in contact with the support surface.

Referring more specifically to FIGS. 3-5, the floral grouping 34 is placed upon the upper surface 14 of the sheet of material 10 in a diagonal orientation. The floral grouping 34 has an upper bloom or foliage portion 42 and a lower stem portion 44. The sheet of material 10 is then wrapped about the floral grouping 34 by the operator (FIGS. 4 and 5), the operator overlapping a portion of the sheet of material 10 over another portion of the sheet of material 10. That is, for example, the operator places the first side 20 of the sheet of material 10 over the floral grouping 34, as shown in FIG. 4. The operator continues to roll the floral grouping 34 and the sheet of material 10 in the direction toward the second side 22 of the sheet of material 10 until the upper surface 14 near the second side 22 firmly engages the lower surface 16 of the sheet of material 10, wherein the floral grouping 34 is substantially encompassed by the sheet material 10, and wherein the bonding material 27 contacts the sheet of material 10 to provide the decorative cover 36 having the decorative pattern 11 formed of glitter which substantially encompasses and surrounds a substantial portion of the floral grouping 34. FIG. 5 shows the floral grouping 34 wrapped in a conical fashion to provide the decorative cover 36 for the floral grouping 34 which has the decorative pattern 11 formed of glitter. When the floral grouping 34 is wrapped in a conical fashion, the bloom portion 42 of the floral grouping 34 is exposed adjacent the open upper end 38 of the decorative cover 36, and the stem portion 44 of the floral grouping 34 is exposed adjacent the lower end 40 of the decorative cover 36.

In another embodiment, illustrated in FIG. 6, the sheet of material 10 having the decorative pattern 11 formed of glitter disposed thereon is utilized to wrap the floral grouping 34 in a cylindrical fashion. The floral grouping 34 is disposed upon the sheet of material 10 approximately parallel to the third side 24 of the sheet of material 10. The sheet of material 10 is then wrapped generally about the stem portion 44 of the floral grouping 34 to a position wherein the third side 24 of the sheet of material 10 generally overlaps the fourth side 26 of the sheet of material 10 in a cylindrical fashion. It should be noted that the sheet of material 10 may be wrapped a plurality of times about the stem portion 44 of the floral grouping 34 before the overlapping of the third side 24 and the fourth side 26 of the sheet of material 10. As before, the portion of the sheet of material 10 near the third side 24 is disposed generally adjacent another portion of the sheet of material 10, and the two adjacent portions then are brought into contact where they may be bondingly engaged, thereby securing the sheet of material 10 generally about the floral grouping 34 so as to provide a decorative cover 36a for the floral grouping 34 which has the decorative pattern 11 formed of glitter disposed thereon.

In another version of the presently disclosed and claimed inventive concept(s), the sheet of material 10 having the decorative pattern 11 formed of glitter applied thereto may be used to wrap a flower pot or pot-type container, as noted above. Shown in FIG. 7 is a flower pot designated by the reference numeral 50 having an open upper end 52, a lower or bottom end 54, an outer peripheral surface 56, and an inner retaining space 58 within which may be disposed a growing medium. The flower pot 50 may contain a botanical item, such as a plant 60, which has an upper portion 62 comprising blooms or foliage or both.

The sheet of material 10 having the decorative pattern 11 formed of glitter may be wrapped about the flower pot 50 by any one of numerous methods used to wrap sheets of material about flower pots to form decorative pot covers for flower pots, such as a decorative cover 61 having the decorative pattern 11 formed of glitter disposed about the flower pot 50 illustrated in FIG. 7. The sheet of material 10 may, for example, be formed by hand about the outer peripheral surface 56 of the flower pot 50 to produce the decorative cover 61 which has the decorative pattern 11 formed of glitter. The decorative cover 61 can then be secured about the flower pot 50 by a bonding material or by a band 64 such that the open upper end 52 of the flower pot 50 remains substantially uncovered by the decorative cover 61 substantially as shown in FIG. 7.

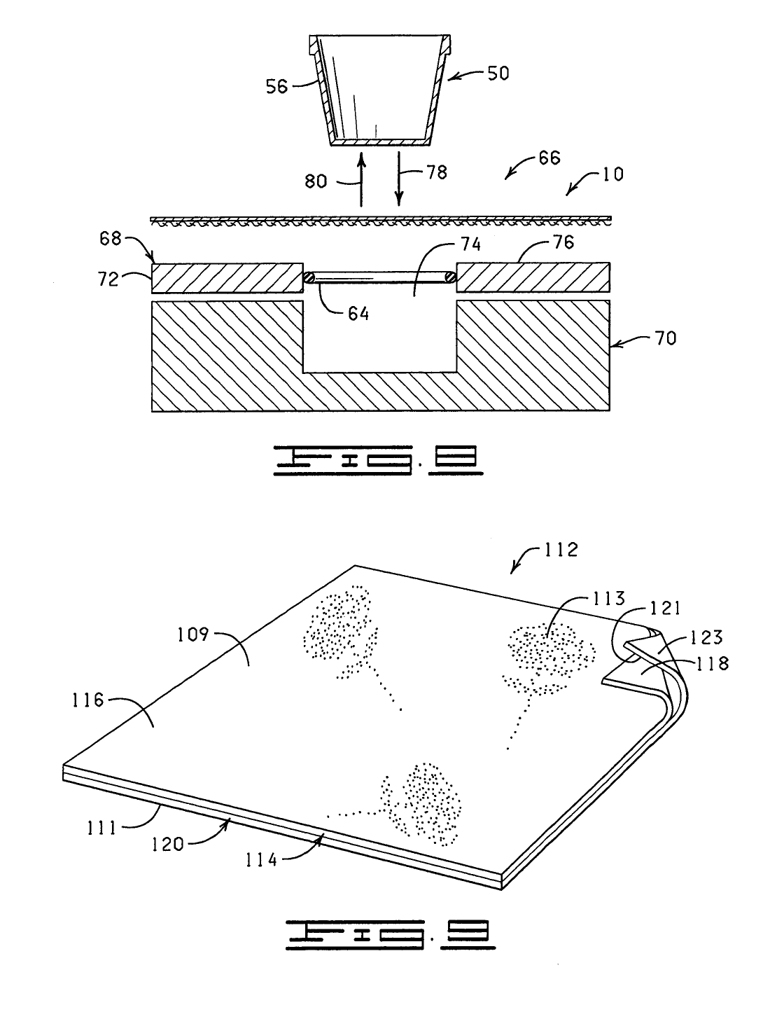

Referring now to FIG. 8, a flower pot cover former and band applicator apparatus 66 for forming the sheet of material 10 into the decorative cover 61 for the flower pot 50 of FIG. 7 is illustrated. The flower pot cover former and band applicator apparatus 66 comprises a band applicator 68 and a flower pot cover former 70. The flower pot cover former and band applicator apparatus 66 has a support platform 72 with an opening 74 formed therein. A band 64, such as elastic band, is disposed circumferentially about the opening 74 in the support platform 72.

The lower surface 16 of the sheet of material 10 is positioned on an upper surface 76 on the support platform 72 such that the sheet of material 10 is positioned over the opening 74 in the support platform 72. The flower pot 50 is positioned above the sheet of material 10 and is moved in a direction 78 into the opening 74 of the flower pot cover former and band applicator apparatus 66. As the flower pot 50 is moved into the opening 74, the sheet of material 10 is pressed about the outer peripheral surface 56 of the flower pot 50, thereby forming the decorative cover 61 about the flower pot 50. The decorative cover 61 is then secured about the flower pot 50 by the band 64. The flower pot 50 having the decorative cover 61 secured thereto is then moved in a direction 80 out of the opening 74 in the support platform 72.

The band 64 can be applied manually or automatically such as by the method shown in U.S. Pat. No. 5,105,599, entitled “MEANS FOR SECURING A DECORATIVE COVER ABOUT A FLOWER POT”, issued to Weder on Apr. 21, 1992, which is hereby expressly incorporated herein by reference. The band 64 can also be applied as a tie using a method such as described in “Single Station Covering and Fastening System”, U.S. Pat. No. 5,609,009, issued to Weder et al on Mar. 11, 1997, the specification of which is hereby expressly incorporated herein by reference. The sheet of material 10 can also be applied automatically about the flower pot 50, for example, by methods shown in U.S. Pat. No. 4,733,521, entitled “COVER FORMING APPARATUS”, issued to Weder et al. on Mar. 29, 1988, and U.S. Pat. No. 5,291,721, entitled “COVER FORMING APPARATUS HAVING PIVOTING FORMING MEMBERS”, issued to Weder et al. on Mar. 8, 1994, both of which are hereby expressly incorporated herein by reference.

Instead of securing the decorative cover 61 about the flower pot 50 via the band 64, the decorative cover 61 formed from the sheet of material 10 having the decorative pattern 11 formed of glitter may be secured to the flower pot 50 by the use of one or more bonding materials. For example, the upper surface 14 of the sheet of material 10 may have a bonding material (such as the bonding material 27) disposed upon a portion thereof. When the sheet of material 10 is disposed about the flower pot 50, at least a portion of the upper surface 14 of the sheet of material 10 contacts the outer peripheral surface 56 of the flower pot 50 and is thereby bonded and held about the flower pot 50 via the bonding material.

The bonding material may cover a portion of the upper surface 14 of the sheet of material 10, or the bonding material may entirely cover the upper surface 14 of the sheet of material 10. The bonding material may be disposed on the upper surface 14 of the sheet of material 10 in the form of a strip or in the form of spaced-apart spots. One method for disposing a bonding material on the sheet of material 10 is described in U.S. Pat. No. 5,111,637, entitled “METHOD FOR WRAPPING A FLORAL GROUPING”, issued to Weder, et al. on May 12, 1992, which is expressly incorporated herein by reference.

The term “bonding material” when used herein includes an adhesive, frequently a pressure sensitive adhesive, a cohesive and any adhesive/cohesive combination having adhesive qualities (i.e., qualities of adhesion or adhesion/cohesion, respectively) sufficient to cause the attachment of a portion of the sheet of material 10 to itself, to a floral grouping 34, or to a flower pot 50. Since the bonding material may comprise either an adhesive or an adhesive/cohesive combination, it will be appreciated that both adhesives and cohesives are known in the art, and both are commercially available. When the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonically sealable and vibratory sealable. The term “bonding material” when used herein also means a heat sealing lacquer or hot melt material which may be applied to the material and, in this instance, heat, sound waves, or vibrations, also must be applied to effect the sealing.

The term “bonding material” when used herein also means any type of material or thing which can be used to effect the bonding or connecting of the two adjacent portions of the sheet of material 10 to effect the connection or bonding described herein. The term “bonding material” may also include ties, labels, bands, ribbons, strings, tapes (including single or double-sided adhesive tapes), staples or combinations thereof. Some of the bonding materials would secure the ends of the material while other bonding materials may bind the circumference of a cover, or a sleeve, or, alternatively and/or in addition, the bonding materials would secure overlapping folds in the material and/or sleeve. Another way to secure the cover and/or sleeve is to heat seal the ends of the material to another portion of the material. One way to do this is to contact the ends with an iron of sufficient heat to heat seal the material.

Alternatively, a cold seal adhesive may be utilized as the bonding material. The cold seal adhesive adheres only to a similar substrate, acting similarly as a cohesive, and binds only to itself. The cold seal adhesive, since it bonds only to a similar substrate, does not cause a residue to build up on equipment, thereby both permitting much more rapid disposition and use of such equipment to form articles and reducing labor costs. Further, since no heat is required to effect the seal, the dwell time, that is, the time for the sheet of material to form and retain the shape of an article, such as a flower pot cover or flower pot, is reduced. A cold seal adhesive binds quickly and easily with minimal pressure, and such a seal is not readily releasable. This characteristic is different from, for example, a pressure sensitive adhesive.

The term “bonding material” when used herein also includes any heat or chemically shrinkable material, and static electrical or other electrical materials, chemical welding materials, magnetic materials, mechanical or barb-type fastening materials or clamps, curl-type characteristics of the film or materials incorporated in material which can cause the material to take on certain shapes, cling films, slots, grooves, shrinkable materials and bands, curl materials, springs, and any type of welding method which may weld portions of the material to itself or to the pot, or to both the material itself and the pot.

Further, if a bonding material is applied to the sheet of material 10, it may be desirable for the bonding material to function as the coating in which the glitter is disposed such that when the bonding material is applied to the sheet of material 10, it provides the decorative pattern 11 formed of glitter. In a further embodiment, two or more sections of bonding material may be applied to the sheet of material 10, wherein at least one section of bonding material functions as the coating in which the glitter is disposed and at least one section of bonding material functions to secure the sheet of material 10 in the form of the decorative cover 61.

### Description of FIGS. 9-12

Referring now to FIGS. 9 through 11, FIG. 9 illustrates a laminated sheet of flexible material 112 having a decorative pattern 113 formed of glitter visible on at least a portion of one surface thereof, wherein the laminated sheet of flexible material 112 may be utilized to construct a decorative preformed flower pot cover 110, as illustrated in FIGS. 10-11. However, the laminated sheet of flexible material 112 is not limited to use in construction of the decorative preformed flower pot cover 110, but rather may be utilized to form any of the decorative covers, sleeves, ribbon or grass described herein.

The sheet of flexible laminated material 112 has an upper surface 109 and a lower surface 111 and comprises a first sheet of material 114 having an upper surface 116 and a lower surface 118, and a second sheet of material 120 having an upper surface 121 and a lower surface 123. At least one surface of the first sheet of material 114 or the second sheet of material 120 has glitter disposed thereon to provide at least a portion of at least one of the upper and lower surfaces 109 and 111 of the sheet of flexible laminated material 112 with the desired decorative pattern 113 formed of glitter. The sheets of material 114 and 120 may be constructed of any materials that will allow the sheet of flexible laminated material 112 to function in accordance with the presently disclosed and claimed inventive concept(s). Preferably, the sheets of material 114 and 120 are each constructed of a material selected from the group consisting of paper, polymeric film, metallized film, foil, cloth, burlap, a material having a texture or appearance simulating cloth or paper, and combinations thereof and laminations thereof.

The first sheet of material 114 desirably has a thickness in a range of from about 0.5 mil to about 10 mil, and more desirably from about 0.6 mil to about 1.25 mil, and the second sheet of material 120 desirably has a thickness in a range of from about 0.5 mil to about 10 mil, and more desirably from about 0.6 mil to about 1.25 mil. The second sheet of material 120 may be laminated to the first sheet of material 114 with a colored adhesive so as to impart a desired color to the laminated sheet of flexible material 112. While the thickness of the sheet of flexible laminated material 112 can vary widely and will generally depend on the thickness of the first sheet of material 114 and the thickness of the second sheet of material 120, desirable results can be obtained where the sheet of flexible laminated material 112 has a thickness in the range of from about 1 mil to about 20 mil, and more desirably from about 1.2 mil to about 2.5 mil.

Numerous ways exist in which the glitter may be disposed on the sheets of material 114 and 120 to provide the sheet of flexible laminated material 112 with the decorative pattern 113 formed of glitter. In one embodiment of the presently disclosed and claimed inventive concept(s), the decorative pattern 113 formed of glitter may be disposed on an outer surface of the sheet of flexible laminated material 112 by disposing the glitter on at least a portion of one of the upper surface 116 of the first sheet of material 114 and the lower surface 123 of the second sheet of material 120. In the alternative, glitter may be disposed between the first sheet of material 114 and second sheet of material 120 by applying the glitter to at least a portion of one of the lower surface 118 of the first sheet of material 114 and the upper surface 121 of the second sheet of material 120, thereby providing at least one of the upper and lower surfaces 109 and 111 of the sheet of flexible laminated material 112 with the decorative pattern 113 formed of glitter. In this instance, it is necessary for at least one of the first and second sheets of material 114 and 120 to be constructed of a material that is substantially transparent or translucent in order for the decorative pattern 113 formed of glitter to be visible therethrough. In yet another alternative, glitter may be applied to both the first sheet of material 114 and the second sheet of material 120, and the two sections of glitter cooperate to provide the sheet of flexible laminated material 112 with the decorative pattern 113 formed of glitter.

The benefits of disposing the decorative pattern 113 formed of glitter between the two sheets of material include the prevention of glitter falling off when handled, package, shredded or baled, thereby maintaining the aesthetic appearance of the decorative cover, sleeve, ribbon or grass formed from the sheet of flexible material 112. An additional advantage of this embodiment includes the prevention of exposing loose glitter to food items that may be wrapped or packaged in a decorative cover, sleeve, ribbon or grass formed from the sheet of flexible, laminated material 112. A further advantage of disposing glitter between the two sheets of material 114 and 120 is the retention of the aesthetic appeal of the decorative grass. The decorative grass is less likely to lose particles of glitter and therefore maintain its sparkling, brilliant ornamental finish when the decorative pattern 113 formed of glitter is disposed between the first sheet of material 114 and second sheet of material 120.

As previously stated, the decorative preformed flower pot cover 110 may be constructed from the sheet of material 10 (FIG. 1), or the sheet of flexible laminated material 112 (FIG. 9). The preformed flower pot cover 110 so formed will have a plurality of overlapping folds 122 formed therein, at least a portion thereof being connected. If desired, the decorative preformed flower pot cover 110 can be formed of a plurality of sheets of the same and/or different types of material. The method and apparatus employed to form the decorative preformed flower pot cover 110 is substantially identical whether one uses one or more sheets of the material 10 (FIG. 1), one or more sheets of the flexible laminated material 112 (FIG. 9) or a combination of such sheets of material. Thus, only the formation of the decorative preformed flower pot cover 110 using the sheet of flexible laminated material 112 of FIG. 9 will be described in detail hereinafter.

The sheet of flexible laminated material 112 may be formed into a decorative preformed flower pot cover 110, as shown in FIGS. 10 and 11. The decorative preformed flower pot cover 110 has an upper end 125, a lower end 126, and an outer peripheral surface 128. An opening 130 intersects the upper end 125, forming an inner peripheral surface 132 which defines and encompasses a retaining space 133 within which a flower pot 134 containing a floral grouping 136 may be disposed in a manner well known in the art. The decorative preformed flower pot cover 110 is provided with a plurality of overlapping folds 122. At least a portion of the overlapping folds may be connected. In one embodiment, the sheet of flexible laminated material 112 may be provided with a bonding material such as acrylic heat sealable laminate disposed thereon (as previously described herein).

The decorative preformed flower pot cover 110 may be formed using a conventional mold system 140 comprising a male mold 142 and a female mold 144 having a mold cavity 146 for matingly receiving the male mold 142 (FIG. 12). The sheet of flexible laminated material 112 is positioned between the male and female molds 142 and 144, respectively. Movement of the male mold 142 in the direction 148 and into the mold cavity 146 forces the sheet of flexible laminated material 112 to be disposed about the portion of the male mold 142 disposed in the mold cavity 146 of the female mold 146 and thereby forms the sheet of material 112 into the preformed decorative flower pot cover 110 (FIGS. 10 and 11). Further, in accordance with the presently disclosed and claimed inventive concept(s), the decorative preformed flower pot cover 110 constructed from the materials described herein above, may have a bonding material disposed upon a portion thereof.

Methods for forming such preformed decorative pot covers are well known in the art. Two methods of forming such covers are described in U.S. Pat. No. 4,773,182, entitled “ARTICLE FORMING SYSTEM”, issued to Weder et al. on Sep. 27, 1988, and U.S. Pat. No. 5,291,721, entitled “COVER FORMING APPARATUS HAVING PIVOTING FORMING MEMBERS”, issued to Weder et al. on Mar. 8, 1994, each of which is expressly incorporated herein by reference.

### Description of FIGS. 13-19

Shown in FIG. 13 is a decorative cover designated therein by the general reference numeral 160 which comprises a flexible bag or sleeve 162 of unitary construction having a decorative pattern 163 formed of glitter in accordance with the presently disclosed and claimed inventive concept(s). The sleeve 162 may be used as a decorative cover 160 for a floral grouping or a flower pot. The sleeve 162 initially comprises a flexible flat collapsed piece of material which is openable in the form of a tube or sleeve. Such sleeves are well known in the floral industry. Further, in accordance with the presently disclosed and claimed inventive concept(s), the decorative cover 160 can be constructed of the sheet of material 10 (FIG. 1), or the sheet of flexible laminated material 112 (FIG. 9), whereby the decorative pattern 163 formed of glitter is visible on an outer peripheral surface 164 of the sleeve 162. The sleeve 162 has an upper end 166, a lower end 168 and the outer peripheral surface 164. The sleeve 162 may be tapered outwardly from the lower end 168 toward a larger diameter at its upper end 166. In its flattened state the sleeve 162 generally has an overall trapezoidal or modified trapezoidal shape, and when opened is substantially frusto-conical to coniform. It will be appreciated, however, that the sleeve 162 may comprise variations on the aforementioned shapes or may comprise significantly altered shapes such as square or rectangular, wherein the sleeve 162 when opened has a cylindrical form, as long as the sleeve 162 functions in accordance with the presently disclosed and claimed inventive concept(s) in the manner described herein. The sleeve 162 (or any other sleeve disclosed herein) may have an angular or contoured shape.

The sleeve 162 has an opening 170 at the upper end 166 and may be open at the lower end 168, or closed with a bottom at the lower end 168. The sleeve 162 also has an inner peripheral surface 172 which, when the sleeve 162 is opened, defines and encompasses an inner retaining space 174. When the lower end 168 of the sleeve 162 is closed, a portion of the lower end 168 may be inwardly or outwardly folded to form one or more gussets for allowing the lower portion of the inner retaining space 174 to be expandable, for example, for receiving the circular bottom of a pot or growing medium.

The decorative pattern 163 formed of glitter may be applied to at least a portion of one of the outer peripheral surface 164 and the inner peripheral surface 172 of the sleeve 162 such that the decorative pattern 163 formed of glitter is visible on the outer peripheral surface 164 of the sleeve 162. Therefore, when the decorative pattern 163 is applied to the inner peripheral surface 172 of the sleeve, at least the portion of the sleeve 162 to which the decorative pattern 163 is applied must be formed of a translucent or transparent material such that the decorative pattern 163 may be visible on the outer peripheral surface 164 of the sleeve 162.

The sleeve 162 is generally frusto-conically shaped, but the sleeve 162 may be, by way of example but not by way of limitation, cylindrical, frusto-conical, a combination of both frusto-conical and cylindrical, or any other shape, as long as the sleeve 162 functions as described herein as noted above. Further, the sleeve 162 may comprise any shape, whether geometric, non-geometric, asymmetrical and/or fanciful as long as it functions in accordance with the presently disclosed and claimed inventive concept(s). The sleeve 162 may also be equipped with drain holes (if having a closed bottom) or side ventilation holes (not shown), or can be made from gas permeable or impermeable materials.

The material from which the sleeve 162 is constructed is the same as previously described above for the sheet of material 10, or the sheet of flexible laminated material 112. Any thickness of material may be utilized in accordance with the presently disclosed and claimed inventive concept(s) as long as the sleeve 162 may be formed as described herein, may be provided with the decorative pattern 163 formed of glitter, and as long as the formed sleeve 162 may contain at least a portion of a flower pot or a floral grouping, as described herein. Additionally, an insulating material such as bubble film, preferable as one of two or more layers, can be utilized in order to provide additional protection for the item, such as a floral grouping, contained therein.

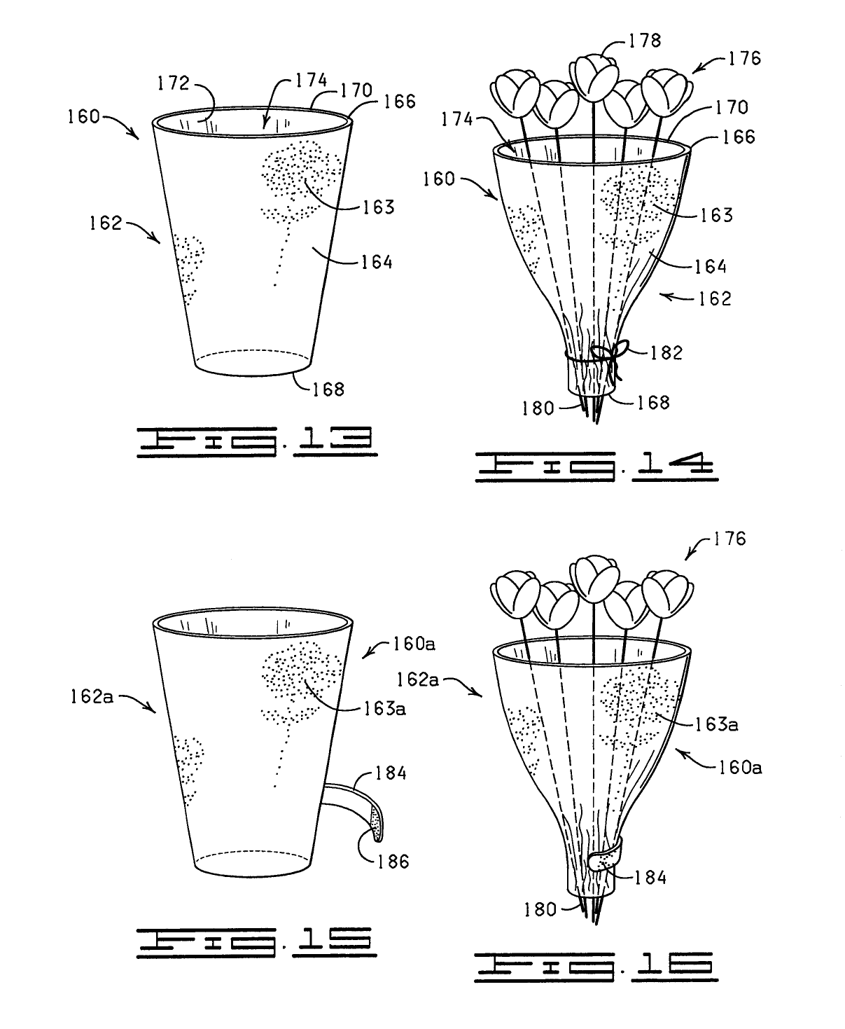

In FIG. 14 the sleeve 162 is illustrated having the decorative pattern 163 formed of glitter visible on the outer peripheral surface 164 of the sleeve 162. A floral grouping 176 is disposed within the inner retaining space 174 of the sleeve 162. Generally, an upper or bloom portion 178 of the floral grouping 176 is exposed adjacent the opening 170 of the sleeve 162 and a lower or stem portion 180 of the floral grouping 176 is exposed adjacent the lower end 168 of the sleeve 162. Either end of the sleeve 162 may be closed about the floral grouping 176. Generally, a portion of the sleeve 162 is tightened about a portion of the stem portion 180 of the floral grouping 176 for holding the decorative cover 160 about the floral grouping 176. For example, the sleeve 162 may be held by a tie 182 tied about the sleeve 162 such as is shown in FIG. 14. Other methods for binding the sleeve 162 may be employed such as the bonding methods and materials described elsewhere herein. For example, as shown in FIG. 15, a decorative cover 160a is shown which comprises a sleeve 162a having a decorative pattern 163a formed of glitter visible thereon and a cinching tab 184 having a bonding material 186 disposed upon a surface thereof. The cinching tab 184 can be used to gather portions of the sleeve 162a together about the stem portion 180 of the floral grouping 176 as shown in FIG. 16 for holding the sleeve 162a tightly about the floral grouping 176.

Similarly, it may generally be desired to use the sleeve 162 as a decorative cover for a flower pot. The flower pot will generally contain a botanical item or plant. The flower pot can be deposited into the open sleeve 162 in a manner well known in the art, such as manually wherein the sleeve 162 is opened by hand and the flower pot deposited therein.

As noted above, a bonding material may be disposed on a portion of the sleeve 162 or any sleeve described herein to assist in holding the sleeve 162 to the flower pot when the flower pot is disposed within the sleeve 162 or to assist in closing the upper end 166 of the sleeve 162 or adhering the sleeve 162 to the flower pot after the flower pot has been disposed therein, as will be discussed in further detail below.

It will be understood that the bonding material, if present, may be disposed as a strip or block on a surface of the sleeve 162. The bonding material may also be disposed upon either the outer peripheral surface 164 or the inner peripheral surface 172 of the sleeve 162, as well as upon the flower pot. Further, the bonding material may be disposed as spots of bonding material, or in any other geometric, non-geometric, asymmetric, or fanciful form, and in any pattern, including covering either the entire inner peripheral surface 172 and/or outer peripheral surface 164 of the sleeve 162 and/or the flower pot. The bonding material may be covered by a cover or release strip which can be removed prior to the use of the sleeve 162 or flower pot. The bonding material can be applied by methods known to those of ordinary skill in their art. One method for disposing a bonding material, in this case an adhesive, is described in U.S. Pat. No. 5,111,637, entitled “METHOD FOR WRAPPING A FLORAL GROUPING”, issued to Weder et al. on May 12, 1993, the specification of which is hereby expressly incorporated herein by reference.

As noted above, a bonding material may be disposed on at least a portion of the inner peripheral surface 172 of the sleeve 162 (or any other sleeve described herein), or, alternatively, the bonding material may be disposed on the outer peripheral surface of a flower pot contained within the sleeve 162, while the sleeve 162 may be free of the bonding material. In a further alternative, the bonding material may be disposed both on at least a portion of the flower pot as well as upon at least a portion of the inner peripheral surface 172 of the sleeve 162. In addition, a portion of the bonding material may also be disposed on the outer peripheral surface 164 of the sleeve 162 as well. It will be understood that the bonding material may be disposed in a solid section of bonding material. The bonding material, when present, is disposed on the sleeve 162 and/or flower pot by any method known in the art.

Certain versions of sleeves described herein may be used in combination with a preformed pot cover. For example, a pot may be disposed in the preformed pot cover, and then the covered pot wrapped or disposed within a sleeve. Either the cover or the sleeve, or both, may have a decorative pattern formed of glitter. Examples of sleeves which may be used in accordance with the presently disclosed and claimed inventive concept(s) are shown in the specification of U.S. Pat. No. 5,625,979, entitled “SLEEVE HAVING A DETACHABLE PORTION FORMING A SKIRT AND METHODS”, issued to Weder on May 6, 1997, which is expressly incorporated herein by reference in its entirety. Equipment and devices for forming sleeves are commercially available, and well known in the art.

Shown in FIGS. 17 and 18 is another embodiment of a decorative cover 160b that comprises a sleeve 162b having a decorative pattern 163b formed of glitter. The sleeve 162b may be constructed from the sheet of material 10 or the sheet of flexible laminated material 112. The sleeve 162b has a “detaching” element in predetermined areas for detaching a portion of the sleeve 162b. The sleeve 162b generally initially comprises a flexible flat collapsed piece of material which is openable in the form of a tube or other conical or frusto-conical configuration. The sleeve 162b is constructed of the same material and in the same way as described previously herein and may be described exactly the same as the other sleeves described herein except for the additional elements described hereinafter.

The sleeve 162b has an upper end 166b, a lower end 168b, and an outer peripheral surface 164b. The sleeve 162b has an opening 170b at the upper end 166b thereof, and the sleeve 162b may be open at the lower end 168b or closed with a bottom at the lower end 168b. In a flattened state, the sleeve 162b has a first side 171 and a second side 173. The sleeve 162b also has an inner peripheral surface 172b which, when the sleeve 162b is opened, defines and encompasses an inner retaining space 174b as shown in FIG. 18. When the lower end 168b of the sleeve 162b has a closed bottom, a portion of the lower end 168b may be inwardly folded to form one or more gussets (not shown) for permitting a circular bottom of an object such as a potted plant 176b to be disposed in the inner retaining space 174b of the lower end 168b of the sleeve 162b.

As shown in FIGS. 17 and 18, the sleeve 162b is demarcated into an upper portion 188 and a lower portion 190. The lower portion 190 of the sleeve 162b is generally sized to contain the flower pot 176b. The upper portion 188 of the sleeve 162b is sized to substantially surround and encompass a plant 192 contained in the flower pot 176b disposed within the lower portion 190 of the sleeve 162b. The sleeve 162b is demarcated into the upper portion 188 and the lower portion 190 by a detaching element 194 for enabling the detachment of the upper portion 188 of the sleeve 162b from the lower portion 190 of the sleeve 162b. In the present version, the detaching element 194 is a plurality of generally laterally-oriented or alternating diagonally-oriented perforations which extend circumferentially around the outer peripheral surface 164b of the sleeve 162b.

In the embodiment shown in FIGS. 17 and 18, the lower portion 190 of the sleeve 162b further comprises a base portion 196 and a skirt portion 198. The base portion 196 comprises that part of the lower portion 190 which, when the flower pot 176b is placed into the lower portion 190, has an inner peripheral surface 172b which is substantially adjacent to and surrounds an outer peripheral surface 199 of the flower pot 176b. The skirt portion 198 comprises that part of the lower portion 190 which extends beyond an open upper end 201 of the flower pot 176b and extends about at least a portion of the plant 192 contained within the flower pot 176b and which is left to freely extend at an angle, inwardly or outwardly, from the base portion 196 when the upper portion 188 of the sleeve 162b is detached from the lower portion 190 of the sleeve 162b by actuation of the detaching element 194.

In the intact sleeve 162b, the skirt portion 198 comprises an upper peripheral edge congruent with the detaching element 194 which is connected to a lower peripheral edge, also congruent with the detaching element 194, of the upper portion 188 of the sleeve 162b. In FIGS. 17 and 18, the upper peripheral edge of the skirt portion 198 is congruent with a series of alternating diagonally-oriented lines of perforations which together form a zig-zag and comprise the detaching element 194. The upper portion 188 of the sleeve 162b may also have an additional detaching element 200 indicated as a plurality of vertical perforations for facilitating removal of the upper portion 188 and which are disposed more or less vertically therein extending between the detaching element 194 of the sleeve 162b and the upper end 166b.

The upper portion 188 of the sleeve 162b is thereby separable from the lower portion 190 of the sleeve 162b by tearing the upper portion 188 along both the detaching element 200 and the detaching element 194, thereby separating the upper portion 188 from the lower portion 190 of the sleeve 162b. The lower portion 190 of the sleeve 162b remains disposed as the base portion 196 about the flower pot 176b and as the skirt portion 198 about a portion of the plant 192 forming a decorative cover 202 as shown in FIG. 19 which substantially surrounds and encompasses the flower pot 176b and a portion of the plant 192 contained therein.

“Detaching element” as used herein, refers to any element, or combination of elements or features, capable of detachment of one portion of an object from another portion. Non-limiting examples of detaching elements that may be used herein include perforations, tear strips, zippers, and any other devices or elements of this nature known in the art, or any combination thereof. Therefore, while perforations are shown and described in detail herein, it will be understood that tear strips, zippers, or any other “detaching elements” known in the art, or any combination thereof, could be substituted therefor and/or used therewith.

The decorative pattern 163b formed of glitter may be applied to at least a portion of one of the outer peripheral surface 164b and the inner peripheral surface 172b of the sleeve 162b such that the decorative pattern 163b formed of glitter is visible on the outer peripheral surface 164b of the sleeve 162b. Therefore, when the decorative pattern 163b is applied to the inner peripheral surface 172b of the sleeve, at least the portion of the sleeve 162b to which the decorative pattern 163b is applied must be formed of a substantially translucent or transparent material such that the decorative pattern 163b may be visible on the outer peripheral surface 164b of the sleeve 162b. The decorative pattern 163b may be disposed on at least one of the upper portion 188 and the lower portion 190 of the sleeve 162b. In addition, if the decorative pattern 163b is disposed on the lower portion 190 of the sleeve 162b, the decorative pattern 163b may be disposed on at least one of the base portion 196 and the skirt portion 198. When the decorative pattern 163b is disposed on more than one of the upper, lower, base and skirt portions 188, 190, 196, and 198, respectively, the decorative pattern 163b may be disposed on the outer peripheral surface 164b of one portion and the inner peripheral surface 172b of the other portion.

In a general method of use of sleeve 162b as a decorative cover for a flower pot, an operator provides a sleeve 162b, and the flower pot 176b having the plant 192 disposed in a growing medium contained within the flower pot 176b. The operator then disposes the flower pot 176b having the plant 192 contained therein into the sleeve 162b by opening the sleeve 162b at its upper end 166b and assuring both that the opening 170b therein is in an open condition, and that the inner peripheral surface 172b of the sleeve 162b is somewhat expanded outward as well, as shown in FIG. 18. The operator then manually or automatically disposes the flower pot 176b into the opening 170b in the sleeve 162b, the flower pot 176b being disposed generally through the upper portion 188 of the sleeve 162b into generally the lower portion 190 of the sleeve 162b, the flower pot 176b remaining in the lower portion 190 of the sleeve 162b, permitting the sleeve 162b to substantially surround and tightly encompass the flower pot 176b. It will be understood that alternatively, the sleeve 162b may be provided with an extension (not shown) and the sleeve 162b may be disposed on rods or wickets, and the flower pot 176b may be disposed in the sleeve 162b either before or after the sleeve 162b has been removed from the wickets.

### Description of FIGS. 20A-20B

Referring now to FIG. 20A, designated generally by the reference numeral 210 is a ribbon material having a decorative pattern 211 formed of glitter disposed on at least a portion of one surface thereof for forming decorative bows and for wrapping items. A web of material having the decorative pattern 211 formed of glitter can be cut in a conventional manner to provide the ribbon material 210 having the decorative pattern 211 formed of glitter.

Any material capable of having the decorative pattern 211 formed of glitter disposed thereon can be employed in the formulation of the ribbon material 210. For example, the material employed to produce the ribbon material 210 can be the sheet of material 10 (FIG. 1).

Referring now to FIG. 20B, designated generally by the reference numeral 220 is another embodiment of a ribbon material having a decorative pattern 221 formed of glitter disposed on at least a portion of one surface thereof for forming decorative bows and for wrapping items. The ribbon material 220 may be formed of any material capable of having the decorative pattern 221 formed of glitter disposed thereon, such as the sheet of flexible laminated material 112.

### Description of FIGS. 21-22B

Referring now to FIG. 21, designated generally by the reference numeral 240 is a system for producing decorative grass 242 having a decorative pattern 243 formed of glitter visible thereon in accordance with the presently disclosed and claimed inventive concept(s). Any material capable of being textured or otherwise modified to provide a web of material 244 with the decorative pattern 243 formed of glitter can be employed to produce the decorative grass 242 having the decorative pattern 243 formed of glitter, such as but not limited to, the sheet of material 10 (FIG. 1) or the sheet of flexible laminated material 112 (FIG. 9).

Referring again to FIG. 21, a roll 248 of the web of material 244 having the decorative pattern 243 formed of glitter disposed thereon is supported on a mandrel 250 having a brake assembly 252 operably connected thereto so that the web of material 244 can be controllably withdrawn from the roll 248. The web of material 244 is passed through a pair of tension or nip rollers 254 and 256 and into a slitter or shredder unit 258 where the web of material 244 is slit to provide a slit web of material 260 having a plurality of strips of predetermined width. The slitting of the web of material 244 to produce the slit web of material 244 having a plurality of strips of predetermined width can be accomplished using any well known method and device. Such common methods of slitting the web of material 244 include: (a) slitting the web of material 244 to produce side-by-side strips of material wherein the longer dimension of the strips is in the direction of travel of the web of material 244, i.e., the machine direction; or (b) slitting the web of material 244 so that the longer dimension of the strips of material are oblique to the direction of travel of the web of material 244, i.e., obliquely to the machine direction.

The slit web of material 260 having a plurality of strips of predetermined width is then passed through a cutting unit 262 where the strips of the slit web of material 260 are cut into segments to form the decorative grass 242 having the decorative pattern 243 formed of glitter disposed on at least a portion of the segments. A segment 264 of the decorative grass 242 having the decorative pattern 243 formed of glitter disposed thereon is illustrated in FIG. 22A.

Any conventional device and method can be employed as the slitter or shredder unit 258 for slitting of the web of material 244 to produce the slit web of material 260 having a plurality of strips of predetermined width and as the cutting unit 262 for cutting the strips of the slit web of material 260 to form the decorative grass 242 having a decorative pattern formed of glitter. Examples of conventional devices which can be used as the slitter or shredder unit 258 and/or as the cutting unit 262 are rotary knives, reciprocating knives, die cutting, laser cutting, water jet cutting, air jet cutting and the like.

The decorative grass 242 having the decorative pattern 243 formed of glitter produced by cutting the strips of the slit web of material 260 can then be conveyed to a storage area (not shown) which may be in the form of a suitable bin, or the decorative grass 242 may be conveyed to a packaging machine, or conveyed to a baling machine for baling prior to storage. As other alternatives, the decorative grass 242 may be placed into boxes or cartons, subjected to further processing immediately or held for subsequent processing.

Referring now to FIG. 22B, designated generally by the reference numeral 266, is a segment of decorative grass 268 having a decorative pattern 269 formed of glitter produced from a laminated material, such as the flexible sheet of laminated material 112 having the decorative pattern 113 formed of glitter hereinbefore described with reference to FIG. 9. It should be understood that the decorative grass 268 having the decorative pattern 269 formed of glitter visible thereon can be produced from any laminated material where at least one surface of the laminated material has a decorative pattern formed of glitter visible on a portion thereof.

The decorative grasses having a decorative pattern formed of glitter prepared in accordance with the presently disclosed and claimed inventive concept(s), such as the decorative grass 242 (FIG. 22A) and the decorative grass 268 (FIG. 22B) can also be provided with various types of curl configurations, can be crimped or otherwise modified. That is, in addition to providing the webs of material from which the decorative grasses are produced with a decorative pattern formed of glitter, various types of curls, crimps and combinations thereof can be imparted to the webs of material prior to slitting the webs of material to produce slit webs of material, or to the slit web of material prior to cutting the slit webs of material to produce the decorative grasses having a decorative pattern formed of glitter. Any method or apparatus capable of imparting the desired curl and/or crimp to the webs of material so that the decorative grasses produced from such webs of material possess both a curl and/or crimped configuration and a decorative pattern formed of glitter can be employed to impart a curl and/or crimp to the webs of material. Examples of various methods and apparatus which may be used to impart curl configurations to the webs of material employed to produce decorative grasses having a decorative pattern formed of glitter are described in U.S. Pat. No. 6,436,324, entitled “METHOD AND APPARATUS FOR MAKING CURLED DECORATIVE GRASS”, issued to Weder et al. on Aug. 20, 2002, the contents of which are hereby expressly incorporated herein by reference in their entirety. Crimping machines capable of imparting the desired crimp to the webs of material so that the decorative grasses produced from such webs of material possess a crimped configuration, as well as having a paper-like appearance are well known and commercially available. One method for imparting a crimp configuration to the webs of material so that the decorative grasses produced from such webs of material possess a crimped configuration, as well as having a paper-like appearance, is disclosed in U.S. Pat. No. 5,891,286, entitled “METHOD OF FORMING CURLED OR CRIMPED DECORATIVE ELEMENTS HAVING AN OPTICAL EFFECT”, issued to Weder et al. on Apr. 6, 1999, the contents of which are hereby expressly incorporated herein by reference in their entirety.

Changes may be made in the construction and the operation of the various components, elements and assemblies described herein or in the steps or the sequence of steps of the methods described herein without departing from the spirit and scope of the presently disclosed and claimed inventive concept(s) as defined in the following claims.

What is claimed:

1. A method for producing decorative grass having a decorative pattern formed of glitter visible on at least a portion of the segments thereof, the method comprising the step of:
cutting a sheet or web of material into a plurality of segments of decorative grass, wherein at least a portion of at least one surface of the sheet or web of material has glitter visible thereon such that at least a portion of the segments of decorative grass have glitter visible on at least a portion of at least one surface thereof.

2. The method of claim 1, wherein the sheet or web of material has a thickness in a range of from about 0.5 mil to about 10 mil.

3. The method of claim 1, further comprising the step of applying a coating having glitter disposed therein to at least a portion of at least one surface of the sheet or web of material, wherein the coating is selected from the group consisting of lacquer, ink, wax, bonding material, and combinations thereof.

4. The method of claim 1, further comprising the steps of:
applying a coating to at least a portion of at least one surface of the sheet or web of material, wherein the coating is selected from the group consisting of lacquer, ink, wax, bonding material, and combinations thereof; and
applying glitter to the coating such that the glitter adheres to the coating, whereby at least a portion of at least one surface of the sheet or web of material has glitter visible thereon.

5. The method of claim 1, further comprising the step of applying a surface coating to at least a portion of the at least one surface of the sheet or web of material having the decorative pattern formed of glitter to prevent the decorative pattern formed of glitter from being distorted, disrupted, and/or destroyed.

6. The method of claim 1, wherein the sheet or web of material is constructed of a material selected from the group consisting of polymeric film, paper, metallized film, foil, cloth, burlap, a sheet of material having a texture or appearance simulating the texture or appearance of paper, a sheet of material having a texture or appearance simulating the texture or appearance of cloth, combinations thereof, and laminations thereof.

7. A method for producing decorative grass having a decorative pattern formed of glitter visible on at least a portion of the segments, the method comprising the step of:
cutting a sheet of flexible, laminated material into a plurality of segments of decorative grass, the sheet of flexible, laminated material having an upper surface and a lower surface wherein at least a portion of at least one of the upper and lower surfaces of the sheet of flexible, laminated material is provided with glitter visible thereon such that at least a portion of the segments of decorative grass have glitter visible on at least a portion of at least one surface thereof, the sheet of flexible, laminated material comprising first and second sheets of material, each having an upper surface and a lower surface, wherein the upper surface of the second sheet of material is laminated to the lower surface of the first sheet of material.

8. The method of claim 7, wherein the glitter is disposed on at least one of the upper surface of the first sheet of material and the lower surface of the second sheet of material laminated thereto so that the glitter is disposed on at least one of the upper and lower surfaces of the sheet of flexible, laminated material.

9. The method of claim 8, wherein a surface coating is applied to the glitter to prevent the glitter from being distorted, disrupted, and/or destroyed.

10. The method of claim 8, further comprising the step of applying a coating having glitter disposed therein to at least a portion of one of the upper surface of the first sheet of material and the lower surface of the second sheet of material, wherein the coating is selected from the group consisting of lacquer, ink, wax, bonding material and combinations thereof.

11. The method of claim 8, further comprising the steps of:
applying a coating to at least a portion of at least one of the upper surface of the first sheet of material and the lower surface of the second sheet of material, wherein the coating is selected from the group consisting of lacquer, ink, wax, bonding material, and combinations thereof; and
applying glitter to the coating such that the glitter adheres to the coating, whereby at least a portion of at least one surface of the sheet of flexible, laminated material has glitter visible thereon.

12. The method of claim 7, wherein the glitter is disposed on at least a portion of at least one of the lower surface of the first sheet of material and the upper surface of the second sheet of material prior to lamination such that the glitter is visible through at least one of the upper and lower surfaces of the sheet of flexible, laminated material.

13. The method of claim 12, wherein the first sheet of material is a substantially transparent or translucent material such that the glitter is visible through the upper surface of the sheet of flexible laminated material.

14. The method of claim 12, wherein the second sheet of material is a substantially transparent or translucent material such that the glitter is visible through the lower surface of the sheet of flexible laminated material.

15. The method of claim 12, further comprising the step of applying a coating having glitter disposed therein to at least a portion of at least one of the lower surface of the first sheet of material and the upper surface of the second sheet of material, wherein the coating is selected from the group consisting of lacquer, ink, wax, bonding material and combinations thereof.

16. The method of claim 12, further comprising the steps of:
applying a coating to at least a portion of at least one of the lower surface of the first sheet of material and the upper surface of the second sheet of material, wherein the coating is selected from the group consisting of lacquer, ink, wax, bonding material, and combinations thereof; and
applying glitter to the coating such that the glitter adheres to the coating, whereby at least a portion of at least one surface of the sheet of flexible, laminated material has glitter visible thereon.

17. The method of claim 7, wherein the first sheet of material has a thickness in a range of from about 0.5 mil to about 10 mil, and the second sheet of material has a thickness in a range from about 0.5 mil to about 10 mil.

18. The method of claim 7, wherein the first and second sheets of material are each constructed of a material selected from the group consisting of polymeric film, paper, metallized film, foil, cloth, burlap, a sheet of material having a texture or appearance simulating the texture or appearance of paper, a sheet of material having a texture or appearance simulating the texture or appearance of cloth, combinations thereof and lamination thereof.
